(19) United States
(12) Patent Application Publication
(10) Pub. No.: US 2025/0266900 A1
(43) Pub. Date: Aug. 21, 2025

(54) PREEMPTIVE MEASUREMENT REPORTS ON DOPPLER OFFSETS FOR PROACTIVE ACTIONS

(71) Applicant: Nokia Technologies Oy, Espoo (FI)

(72) Inventors: Rafhael MEDEIROS DE AMORIM, Aalborg (DK); Konstantinos MANOLAKIS, Munich (DE); Frank FREDERIKSEN, Klarup (DK); Jeroen WIGARD, Klarup (DK)

(21) Appl. No.: 18/859,374

(22) PCT Filed: Apr. 25, 2022
(86) PCT No.: PCT/EP2022/060806

§ 371 Date: Oct. 23, 2024

(51) Int. Cl. H04B 7/185; H04B 7/195

(52) U.S. Cl. CPC H04B 7/18532; H04B 7/1855; H04B 7/18589; H04B 7/195

(57) ABSTRACT

Systems, methods, apparatuses, and computer program products for preemptive measurement reports are provided. One method may include detecting, by a user equipment, a potential for creating interference to at least one network node. Based on the detection of the potential for creating the interference, the method may include transmitting an alert report, to a serving node of the user equipment, to indicate the potential for creating the interference to the at least one network node.

### FIELD

Some example embodiments may generally relate to communications including mobile or wireless telecommunication systems, such as Long Term Evolution (LTE) or fifth generation (5G) radio access technology or new radio (NR) access technology or 5G beyond (e.g., 6G) access technology, or other communications systems. For example, certain example embodiments may generally relate to NR over non-terrestrial networks (NTN).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology, 5G beyond and/or sixth generation (6G) radio access technology. 5G wireless systems refer to the next generation (NG) of radio systems and network architecture. A 5G system may be mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 5G beyond or 6G is expected to support further use cases beyond current mobile use scenarios, such as virtual and augmented reality, artificial intelligence, instant communications, improved support of IoT, etc.

### SUMMARY

An embodiment may be directed to an apparatus including at least one processor and at least one memory comprising computer program code. The at least one memory and computer program code configured, with the at least one processor, to cause the apparatus at least to detect a potential for creating interference to at least one network node and, based on the detection of the potential for creating the interference, transmit an alert report, to a serving node of the apparatus, to indicate the potential for creating the interference to the at least one network node.

An embodiment may be directed to an apparatus including at least one processor and at least one memory comprising computer program code. The at least one memory and computer program code configured, with the at least one processor, to cause the apparatus at least to receive an alert report, from a user equipment, to indicate a potential for creating interference to at least one network node, and to initiate interference mitigation to prevent or reduce the interference to the at least one network node.

An embodiment may be directed to a method including detecting, by a user equipment, a potential for creating interference to at least one network node. The method may also include, based on the detecting of the potential for creating the interference, transmitting an alert report, to a serving node of the user equipment, to indicate the potential for creating the interference to the at least one network node.

An embodiment may be directed to a method including receiving, by a network node serving a user equipment, an alert report from the user equipment, wherein the alert report indicates a potential for creating interference to at least one network node. The method may also include initiating interference mitigation to prevent or reduce the interference to the at least one network node.

An embodiment may be directed to an apparatus including means for detecting a potential for creating interference to at least one network node and, based on the detecting of the potential for creating the interference, means for transmitting an alert report, to a serving node of the apparatus, to indicate the potential for creating the interference to the at least one network node.

An embodiment may be directed to an apparatus including means for receiving an alert report, from a user equipment, to indicate a potential for creating interference to at least one network node, and means for initiating interference mitigation to prevent or reduce the interference to the at least one network node.

An embodiment may be directed to a computer readable medium comprising program instructions stored thereon for performing at least the following: detecting a potential for creating interference to at least one network node and based on the detecting of the potential for creating the interference, transmitting an alert report, to a serving node, to indicate the potential for creating the interference to the at least one network node.

An embodiment may be directed to a computer readable medium comprising program instructions stored thereon for performing at least the following: receiving an alert report, from a user equipment, indicating a potential for creating interference to at least one network node, and initiating interference mitigation to prevent or reduce the interference to the at least one network node.

### BRIEF DESCRIPTION OF THE DRAWINGS

For proper understanding of example embodiments, reference should be made to the accompanying drawings, wherein:

FIG. 1 illustrates an example of a system depicting an interference scenario, according to an embodiment;

FIG. 2 illustrates an example flow diagram of a method, according to an embodiment;

FIG. 3 illustrates an example flow diagram of a method, according to an embodiment; and

FIG. 4 illustrates an example of a system including multiple apparatuses, according to certain embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for preemptive measurement reports, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. Further, the terms “cell”, “node”, “gNB”, “satellite”, or other similar language throughout this specification may be used interchangeably.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain example embodiments may relate to the field of NR over non-terrestrial networks (NTN). The 3GPP technologies were initially designed for terrestrial applications, with fixed base stations. Most of the procedures, including timing and frequency compensation are developed for such scenarios.

The 3GPP systems are based on synchronicity between the UEs and the gNBs (NR base stations), in both time and frequency domains. In downlink (DL), the synchronicity is achieved in timing when the UE reads the synchronization signals (primary synchronization signals (PSS) and secondary synchronizations signals (SSS)) broadcasted by the NR cells. Because of the physical delays experienced by the signal due to the propagation between the two nodes, the DL timing reference is different in the gNB (transmit time) and the UE (reception time). The systems are designed to operate with such offset, which in terrestrial networks (TN) is relatively small. In the frequency domain, the UE searches for potential NR cells by looking at the synchronization blocks (which carry synchronization signals) in pre-determined frequencies, the so called synchronization rasters. In standalone operation, the frequency position of the synchronization signal (SS) block is defined by a number called Global Synchronization Channel Number (GSCN). The UE searches for frequencies within the valid GSCNs. From detecting the PSS/SSS, the UE can then detect and compensate any frequency misalignments due to its hardware, such as the local osciallator's carrier frequency offset (CFO).

In uplink (UL), at the initial transmission (random access), the UE is not assumed to be synchronized with the network. Upon the reception of the random access special sequences (preambles), the gNB will inform the UE about timing advance (TA) offset the UE should apply to the next UL transmission in order to be aligned with the UL timing at gNB. This is necessary because the UEs should have similar UL timing reference at the reception timing by the gNB in order to avoid interference between UEs allocated in different slots in time. In the frequency domain, the gNB signals to the UE the GSCN for the UL transmission.

Because UEs are considered mobile nodes in 3GPP networks, there may be Doppler offset in the frequency domain caused by the UEs relative velocity to the gNB. The UE is expected to capture, via DL measurements, the current Doppler offset compared to the reference value of the GSCN and use it to estimate in ppm (parts per million) the Doppler offset to be used in UL. For UL transmission, the UE then adjusts its carrier frequency based on the DL frequency synchronization, in order to account for hardware frequency errors as well as Doppler frequency offsets experienced on the service link.

Although some applications, also consider high-speed UEs connected to 3GPP networks, such as UEs on trains or airplanes (300-1000 km/h); and some features are developed for enhanced coverage (e.g., dozens of kms), NTN has provided much more challenging scenarios for UEs synchronization.

In 3GPP NTN, the satellite used for transmitting the NR signal may be travelling at orbits at 300 kms of altitude (Low-Earth Orbit) to more than 35000 kms (GEO and HEO, although HEO is not currently considered for NR over NTN). Table 1 below (corresponding to Table 4.1-1 in 3GPP TR 38.821) presents the reference values for these scenarios:

TABLE 1
Types of NTN platforms

| | | | | Typical | |
|---|---|---|---|---|---|
| | | | | beam | |
| | | | | footprint | |
| Platforms | Altitude range | | Orbit | size | |
| Low-Earth | 300-1500 | km | Circular around | 100-1000 | km |
| Orbit (LEO) | | | the earth | | |
| satellite | | | | | |
| Medium- | 7000-25000 | km | | 100-1000 | km |
| Earth Orbit | | | | | |
| (MEO) | | | | | |
| satellite | | | | | |
| Geostationary | 35 786 | km | notional station | 200-3500 | km |
| Earth Orbit | | | keeping position | | |
| (GEO) | | | fixed in terms of | | |
| satellite | | | elevation/azimuth | | |
| UAS platform | 8-50 km | | with respect to | 5-200 | km |
| (including | (20 km for HAPS) | | a given | | |
| HAPS) | | | earth point | | |
| High Elliptical | 400-50000 | km | Elliptical around | 200-3500 | km |
| Orbit (HEO) | | | the earth | | |
| satellite | | | | | |

The velocities observed in NTN scenarios are much higher than those ever considered for terrestrial applications in NR. A Low-Earth Orbit (LEO) satellite, for instance, may be travelling at a relative speed of 7.5 km/s (˜27000 km/h).

The high relative speeds observed in NTN for LEO and Medium-Earth Orbit (MEO) deployments cause the Doppler shift to be considerably higher in NTN. For example, Doppler shifts on the order of more than 20 parts per million (ppm), are expected for LEO satellites. This corresponds to a shift of 15 kHz (the lowest subcarrier spacing (SCS) allowed in NR) already at 750 MHz. For frequencies above 9 GHz (for example frequency range 2 (FR2) frequencies) this would correspond to a Doppler shift equivalent to one or more physical resource blocks (PRB).

It has been initially agreed that the UL frequency pre-compensation is to be performed by the UE, based on the UE position (acquired via Global Navigation Satellite System (GNSS)) and the satellite ephemeris. This means a UE is expected to perform a Doppler pre-compensation of several kHz to ensure that UL signals from different UEs are received at the satellite antenna with zero Doppler offset (basically cancelling the effects of the Doppler experienced on the UL direction of the service link).

A similar situation is observed for the timing advance pre-compensation by the UE. Current agreements state that the timing advance at the UE side is expected to have a UE-specific component, which is to be calculated by the UE based on the satellite ephemeris and its own position (acquired via GNSS). The “autonomously acquired” component is a new feature in NTN, compared to legacy TN requirements, and it was introduced because the large delays observed in NTN, together with a wide range between the minimum and maximum delays experienced by users in the same cell, make it difficult for the gNB to decode the random access preamble transmission and then estimate the full TA to be compensated by the UE.

Among the scenarios that can be addressed by example embodiments described herein include a situation where more than one layer (high altitude platform station (HAPS), LEO, geostationary orbit (GEO), MEO) are available for the UE in a dynamic and flexible manner, such that the advantages of each of the deployments may be fully used by the network. In addition, the service link used by those layers may share the same frequency band or potentially use adjacent frequency bands. Furthermore, example embodiments can avoid interference in a scenario where one layer is available for the UE and other layers are used by other UEs.

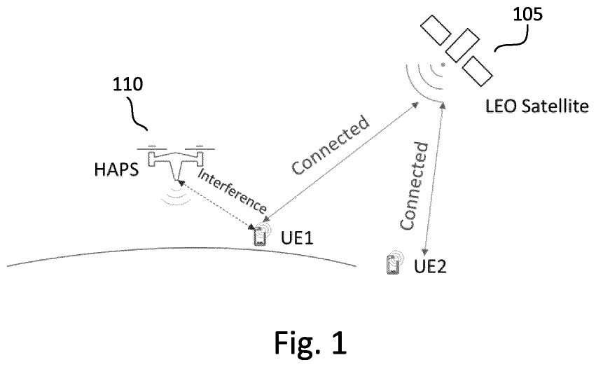

FIG. 1 illustrates one example of an interference scenario. In the example of FIG. 1, two UEs, UE1 and UE2, are connected to a NR operator via a LEO satellite deployment 105. At some point, one of the UEs (UE1) notices the approximation of a HAPS 110 from the same operator or from another operator. The HAPS 110 may have been deployed to cover a different region (e.g., a different country), or the UE may not be able to connect to HAPS 110. In other words, this UE is not expected to perform the handover from the LEO satellite 105 to the HAPS 110. Because NTN cells created by LEO are expected to be much larger than the coverage area of a HAPS, there will be often cases where UE2 is not capable of detecting the same HAPS as UE1 does.

In general, there may be interference management or interference mitigation techniques deployed between the different cells in the network or multiple networks, including between the HAPS and the LEO of the same operator. For example, by assigning different 5G NR bandwidth parts (BWP) in HAPS and LEO, in order to carry most of their respective traffic loads.

However, for the duration of the service provided by the LEO satellite to the UE1, the Doppler shift on the service link between the LEO and UE1 may vary from −20 ppm to +20 ppm with respect to the carrier frequency, which corresponds to multiple of subcarrier spacings (SCS). This means that even if the different network layers (HAPS and LEO in the example of FIG. 1) are using different BWPs, the UE's UL transmission may potentially interfere on different PRBs at the NTN node other than the intended one (HAPS gNB). Therefore, even a BWP separation may not be enough to fully protect the cells from interference for the whole duration of the flight. Introducing frequency guard bands is seen as sub-optimal, as it would result into unused resources and reduce the overall system throughput. Moreover, there is a dynamic factor as the parts of the spectrum affected by the interference generated by UE1 are different over time, due to the time-varying nature of the Doppler shift. Most of the interference management techniques and algorithms do not consider interfering sources that are “sliding” in the frequency domain from large negative to large positive numbers, and usually they consider that the interfering source is aligned in frequency with the relevant signal.

Furthermore, on top of the Doppler variation, there is also a timing difference variation. As an example, if the UL signal from UE1 is pre-compensated to provide slot N at a specific time at the satellite located for example at 800 kms example of distance, the timing advance must correspond to a transmission at 5.33 ms before the slot N. The same transmission by the UE will arrive at a HAPS at 40 kms distance after only 0.13 ms after its transmission. As the distances also vary significantly between the LEO and the UE, there will be also a dynamic misalignment in time of the interference caused by the UE in the HAPS PRBs. The large time misalignment between the signals does not allow for deployment of beam-based interference mitigation.

In DL, similar effects may be observed, but from the UE perspective on the ground. As some pre-compensation may be applied by the LEO satellite and the HAPS system, the difference observed might be “residual” difference based on the differential Doppler observed by the UE at its own location relative to the compensated version by the LEO and the HAPS.

This problem is relevant as there has been consideration given to the possibility for TN and NTN to share similar RAN resources (frequency bands, for example). The same has been considered for different NTN layers, where LEO and MEO may share the same frequency bands. The example of FIG. 1 discussed above relates to the HAPS<->LEO situation, but similar problems apply to several different scenarios, such as: LEO<->MEO, LEO<->GEO, and LEO<->LEO (two satellites in different orbits observe different Doppler shifts and timing advance from the same UE).

In TN, the difference in timing and the Doppler shift are not relevant compared to the duration of the slot in time and frequency for this to impact the interference management procedures. However, if NTN and TN share frequency resources, similar issues may be observed.

Certain embodiments provide a new procedure that may include measurements and signalling for a UE to provide so-called “alert reports” to the serving gNB/NR-RAN, which allows for preventive actions at the gNB/NR-RAN for interference management procedures so that the UE avoids creating interference to other NTN objects or to the TN.

In an embodiment, the decision of the UE to send an “alert report” may be triggered by the detection of other NTN/TN cells using either the same carrier frequency or adjacent frequency bands as configured for the UE by its serving gNB, plus the UE's Doppler shift and timing advance pre-compensation to be used in the UL, as well as whether these values are above certain limits and would potentially create interference to the other system. For example, this may be due to signal leakage because of large frequency pre-compensation into other systems' frequency bands.

In this way, the gNB can become aware of the situation and associated risk and is able to steer its interference mitigation strategy for the UL. For instance, the interference mitigation may include UE power control, frequency band usage and/or resource allocation scheme to instruct the UE in such way that it will not interfere in the UL to another NTN object/node that the intended one.

According to some embodiments, as part of the alert report, additional time-stamped assistance information may be provided by the UE to the serving gNB. The assistance information may include, for example, timing advance and Doppler pre-compensation used for the serving cell and a number of neighbor cells (which may or may not be on the same orbital height).

In certain embodiments, the reporting may be triggered by autonomous detection on the UE side or may be configured by the gNB as part of a measurement configurations and signaling framework.

In one embodiment, a UE may utilize autonomous detection of interference in DL or a potential situation of UL interference to provide early or pre-emptive reports. The detection of this situation may be based on downlink measurements (e.g., Doppler and timing), on information already provided by the gBN (TA commands, ephemeris information), and/or on GNSS location information etc.

According to this embodiment, the UE connected to a cell in one NTN platform (a satellite in a given orbit, herein called serving satellite) may identify the presence of other cells, being transmitted by a different NTN platform (a different satellite or HAPS) or by a TN gNB. This corresponds to the case where the other cells are active on the same frequency carrier as the serving cell, or in any of the frequency carriers configured in the UE, and/or are active on the same/adjacent frequency bands/BWPs/resource blocks as the UE. Optionally, in an embodiment, the detection may be also based on the ephemeris of neighbor satellites (or neighbor HAPS) that is broadcast by the serving satellites. In an embodiment, the UE may use the neighbor satellite information to determine when a neighbor satellite is within range of interference (in both Doppler domain and time domain). Therefore, in case the ephemeris of the neighboring satellite is not provided via the serving satellite, the UE may receive and decode the system information block (SIB) or any other control information from the neighboring satellite, where the ephemeris is provided.

As an additional embodiment, the UE may consider its antenna or beamforming implementation and capabilities to determine the range of interference in combination with the serving cell ephemeris.

Upon detecting the interference or risk for causing interference, the UE may utilize its knowledge on the serving satellite ephemeris and/or its own time and frequency pre-compensation values, in order to calculate the instants in time where the Doppler shift variation exceeds a relevant threshold in a positive or negative direction. The relevant threshold may be used to indicate significant adjacent channel interference, which is usually not subject to common interference mitigation techniques available in cellular networks. Where the adjacent channel may represent subcarriers or PRBs in the frequency domain that may be allocated to other users (or other logical channels). The threshold may be calculated based on a series of parameters and reported in different manners, such as SCS used in this frequency band, maximum Doppler shift in kHz, and/or number of PRBs impacted (in full PRBs or fractions of PRBs). In an embodiment, the procedure described above may also be used to provide (in the same or different reporting message) the “co-channel” interference estimated time.

It is noted that, in case of two satellites, the UE may use the ephemeris of the neighbor satellite to also calculate the relative offset in frequency and timing observed by/caused from this UE relative to both satellites. In this case, the relative offset and interference created due to this value can be evaluated against the above thresholds.

According to an embodiment, the UE may be configured to send the measurement report(s) to the gNB. This can be done using legacy signalling solutions, such as the UE requesting resources for submitting the report or the allocation of pre-defined gNB resources.

In an embodiment, the UE may then send an alert report to the serving gNB indicating the event of potentially, or likelihood of, creating interference to another NTN or TN node. Moreover, the report may include information of the node and its cell ID (PCI or other ID), and/or optionally may include (relative) timing advance and frequency Doppler measurements to the serving cell, the beam index to be used etc. The measurements may be provided along with time stamps (UTC time, System Frame Number (SFN), subframe number or slot number in the frame) pointing to the time instant of when the UL transmission will be potentially affecting neighbor nodes as indicated by the reported parameters.

The time stamps, if provided based on system timing (SFN, slot number etc.) can be understood by the serving gNB. In order for the gNB to be able to confirm the risk of interference that the UE reports and moreover take concrete actions, the serving gNB needs to have understanding of the timing of the other node. In case this is not know in advance by the gNB, the UE can provide relevant information to the serving gNB as part of the alert report measurements, e.g., including a (relative) time offset and/or SFN offset between the other node (e.g. HAPS gNB) and the serving gNB.

One example of frequency Doppler reporting may be as follows:
EarlyDopplerOffsetIndication:
Unit: 2 SCS.
Current value: 2
Transitions: +1 in SFN X
   +1 inSFNX+Δ₁
   +1 inSFNX+Δ₁+Δ₂
   −1 inSFNX+Δ₁+Δ₂+Δ₃

In the example above, the UE is transmitting a Doppler shift indication, where each unit correspond to 2 SCS. The current value, i.e., the Doppler shift measured in the moment the trigger was launched is equal to 2 units (4 SCS). Then, at every transition time marked in the report by a given SFN, the UE expects the Doppler shift to increase/decrease in 1 unit (2 SCS for the above example) according to the value indicated.

In a further embodiment, the gNB may set the measurement configurations for the UE, specifying the thresholds, the time stamp units and the measurement objects to be reported. Optionally, the gNB may include the ephemeris of the neighbour satellite or HAPS to be reported. The UE may defer the report, in this case, if the UL transmission is expected to end before the interference window or if the UE is expected to be on discontinuous reception (DRX) sleep mode.

In yet another embodiment, the UE may identify additional interference in certain subcarriers (usually in the edge of the PRBs allocated) sliding in frequency domain over time and this may become a trigger for UE to search for the platform causing this interference and triggering the reports.

Optionally, in an embodiment, the UE may use knowledge on its own directional antenna beams/panels, to estimate at which points in time the UE will be transmitting with high directivity in a direction that affects the victim cell, and providing reporting exclusively for the window of time this happens. It is noted that “high directivity” can be caused by the use of a directional antenna of any kind, meaning that the UE will not interfere with or receive interference from all directions, but only in the selected direction with a certain antenna width. A justification for this implementation may be that the relative Doppler offset and TA may not be relevant for interference management, if beam directivity can protect the UE/victim cells from interference. Additionally, on this type of reporting, the UE may provide the predicted antenna coupling gain from UE side (or pathloss) towards the cells belonging to the neighbor platform.

In some embodiments, to save some bits, the report may comprise two separate fields for positive and negative increments (reducing the need to indicate +1 and −1 before the time stamp). According to an embodiment, the unit of the report may be implicit and pre-configured by the gNB (via RRC) or hard-coded in specifications.

According to certain embodiments, the trigger for the reporting may also be a Random Access procedure, where the UE already has identified, prior to initiating the Random Access, the presence of more than one satellite or gNB platform in the area. In an embodiment, a similar reporting may be also provided for relative timing advance indication (relativeTimingAdvance reporting), using relevant units for the relative timing difference observed (symbol duration, slot duration, subframe duration).

In some embodiments, the report may contain the target object the UE has measured (the HAPS indication, the satellite ephemeris of the second satellite, etc.). In some cases, the report may contain a list of reports for different targets.

According to an embodiment, if the UE knows a handover (HO) to another platform is bound to happen or that the connection will be terminated soon, the UE may defer the transmission of the report or provide an early termination for the list of time stamps for the transitions.

Because of unpaired spectrum, the frequency Doppler offset in absolute terms observed in DL and UL may be different. This difference may be take in account by the UE when calculating the UL report values in form of a scaling factor to be applied to the Doppler values as obtained from DL measurements.

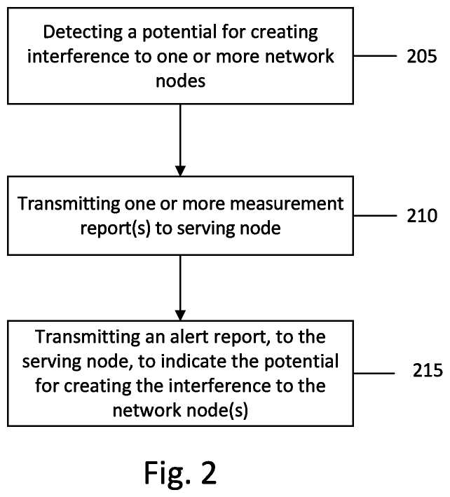

FIG. 2 illustrates an example flow diagram of a method for pre-emptive measurement and/or alert reporting, for example, to avoid creating interference to other NTN or TN nodes, according to an example embodiment.

In certain example embodiments, the flow diagram of FIG. 2 may be performed by a network entity or communication device in a communications system such as, but not limited to, LTE, 5G NR, or 5G beyond.

For instance, in some example embodiments, the communication device performing the method of FIG. 2 may include a user device, UE, sidelink (SL) UE, wireless device, mobile station, IoT device, UE type of roadside unit (RSU), a wireless transmit/receive unit, customer premises equipment (CPE), other mobile or stationary device, or the like. For instance, in certain example embodiments, the method of FIG. 2 may include procedures or operations that may be performed by a UE1, as described or illustrated elsewhere herein, such as in FIG. 1. In an embodiment, one or more of the procedures illustrated in the example of FIG. 2 may be performed by apparatus discussed below.

As illustrated in the example of FIG. 2, the method may include, at 205, detecting, by the UE, a potential or a risk for creating interference to one or more network nodes, such as NTN or TN node(s). For example, the one or more network nodes may include a satellite, HAPS, gNB, NR-RAN node, or other platform or network node.

In one embodiment, the detecting 205 may include autonomously detecting, by the UE, the potential for creating the interference to the network node(s) (i.e., victim network node(s)) based on one or more of DL measurements, information provided by the serving node (e.g., gNB) serving the UE, ephemeris information of the serving node, and/or GNSS location information. According to some embodiments, the detecting 205 may include detecting that the network node(s) is using a same carrier frequency and/or adjacent frequency bands as configured for the UE by the serving node.

According to certain embodiments, the detecting 205 may include determining whether values of the UE's Doppler shift and timing advance pre-compensation to be used in UL are above certain limits or thresholds that would create the interference to the network node(s), for example, due to signal leakage because of large frequency pre-compensation into the network node(s) frequency bands. For example, the UE may utilize its knowledge on the serving node's ephemeris and/or its own time and frequency pre-compensation values to calculate instants in time where the Doppler shift variation exceeds those certain limits or thresholds in a positive or negative direction, where the adjacent channel represents subcarrier or PRBs in the frequency domain that can be allocated to other users. In some embodiments, the limit or threshold may be calculated based on a series of parameters and reported in different manners, such as SCS used in this frequency band, maximum Doppler shift in kHz, and/or number of PRBs impacted (in full PRBs or fractions of PRBs). In a further embodiment, the UE may also be configured to provide (in the same or different reporting message) the “co-channel” interference estimated time. In a case where the network node(s) include two satellites, the UE may use the ephemeris of the neighbor satellite to also calculate the relative offset in frequency and timing observed by/caused from the UE relative to both satellites. In this case, the relative offset and interference created due to this value may be evaluated against the above-noted limits or thresholds.

In some embodiments, the network node(s) may include a neighbor satellite or HAPS, and the detecting 205 may include using the neighbor satellite or HAPS information including at least ephemeris information to determine when the neighbor satellite or HAPS is within range of interference in Doppler domain and/or time domain. According to an embodiment, the range of interference may be detected based on the UE's antenna or beamforming capabilities in combination with the ephemeris information.

According to one embodiment, the method may include, at 210, transmitting one or more measurement report(s) to the serving node (e.g., gNB). This can be done, for example, using legacy signalling solutions, such as the UE requesting resources for submitting the report or the allocation of pre-defined gNB resources.

In an embodiment, based on the UE detecting the potential for creating the interference to the network node(s) the method may then include, at 215, transmitting an alert report, to the serving node, to indicate the potential for creating the interference to the network node(s). In other words, the UE detecting the potential or risk for causing the interference to the network node(s) may trigger the UE to transmit the alert report to the serving node so that it is aware of the possible interference and can take actions to prevent or mitigate the interference.

According to some embodiments, the alert report may include time-stamped assistance information including one or more of: information of the network node(s) and their cell identifier (s), timing advance and frequency Doppler measurements used for the serving node and the network node(s), and/or a beam index to be used. For example, in an embodiment, the assistance information may include a relative time offset or system frame number (SFN) offset between the network node(s) and the serving node.

In some embodiments, to save some bits, the alert report may include two separate fields for positive and negative increments (reducing the need to indicate +1 and −1 before the time stamp). According to certain embodiments, the trigger for the transmitting 215 of the alert report may also be a Random Access procedure, where the UE already has identified, prior to initiating the Random Access, the presence of more than one satellite or gNB platform in the area. In an embodiment, a similar report may be also provided for relative timing advance indication (relativeTimingAdvance reporting), using relevant units for the relative timing difference observed (symbol duration, slot duration, subframe duration).

According to some embodiments, the alert report may contain the target object the UE has measured (the HAPS indication, the satellite ephemeris of the second satellite, etc.). Additionally, in some cases, the alert report may contain a list of reports for different targets.

According to an embodiment, if the UE knows a HO to another satellite or gNB platform will happen or that the current connection will be terminated soon, the UE may defer the transmitting 215 of the alert report or provide an early termination for the list of time stamps for the transitions.

According to a further embodiment, the detecting 205 may include the UE receiving, from the serving node, configuration information specifying at least one of thresholds, time stamp units, or measurement objects to be reported in the alert report, and optionally receiving the ephemeris information of the neighbor satellite or HAPS. In this case, if UL transmission is expected to end before a window for the interference or when the UE is expected to be in discontinuous reception mode, the UE may defer the transmitting of the alert report.

In some embodiments, the detecting 205 may include identifying additional interference in certain subcarriers sliding in frequency domain over time, where the identifying of the additional interference triggers the UE to search for a platform causing the additional interference.

According to certain embodiments, the detecting 205 may include using knowledge of the UE's own directional antenna beams or panels to estimate at which points in time the UE will be transmitting with high directivity in a direction that affects the network node(s), and the alert report may include information for a window of time that the transmitting in the direction that affects the network node(s) occurs.

In some embodiments, the method may also include, in response to the alert report, the UE receiving instructions from the serving node to mitigate or prevent the interference to the network node(s). For example, the instructions may include modifications to the UE's power control, frequency band usage and/or resource allocation.

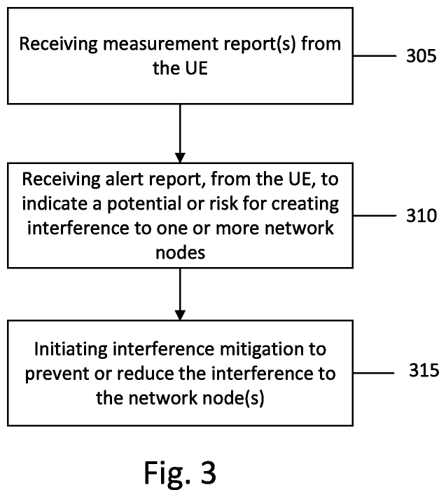

FIG. 3 illustrates an example flow diagram of a method for pre-emotive measurement and/or alert reporting, for example, to avoid creating interference to other NTN or TN nodes, according to an example embodiment.

In certain example embodiments, the flow diagram of FIG. 3 may be performed by a network entity or communication device in a communications system such as, but not limited to, LTE, 5G NR, or 5G beyond.

For instance, in some example embodiments, the device performing the method of FIG. 3 may include a network node, satellite, base station, a Node B, an evolved Node B (eNB), 5G Node B or access point, next generation Node B (NG-NB or gNB), TRP, HAPS, Remote Radio Head (RRH), integrated access and backhaul (IAB) node, and/or a WLAN access point, other radio node, or the like. For example, in one embodiment, the method of FIG. 3 may be performed by a serving node or gNB serving a UE, such as apparatus 10 discussed below.

As illustrated in the example of FIG. 3, the method may include, at 305, receiving one or more measurement reports from the UE. In an embodiment, the method may then include, at 310, receiving an alert report, from the UE, to indicate a potential or risk for creating interference to one or more network nodes, such as a satellite, HAPS and/or gNB.

According to some embodiments, the alert report may include time-stamped assistance information including one or more of: information of the network node(s) (i.e., victim nodes) and their cell identifier (s), timing advance and frequency Doppler measurements used for the serving node and the network node(s), and/or a beam index to be used. For example, in an embodiment, the assistance information may include a relative time offset or system frame number (SFN) offset between the network node(s) and the serving node. In one embodiment, the alert report may specifically include information for a window of time that the UE is transmitting in a direction that affects the network node(s).

According to some embodiments, the method may include transmitting, to the UE, configuration information specifying at least one of thresholds, time stamp units, or measurement objects to be reported in the alert report, and optionally transmitting, to the UE, ephemeris information of the network node(s).

In certain embodiments, responsive to receiving the alert report indicating the potential or risk for creating interference, the method may include, at 315, initiating interference mitigation to prevent or reduce the interference to the network node(s). For example, the interference mitigation may include one or more of: modifying UE power control, frequency band usage, and/or resource allocation.

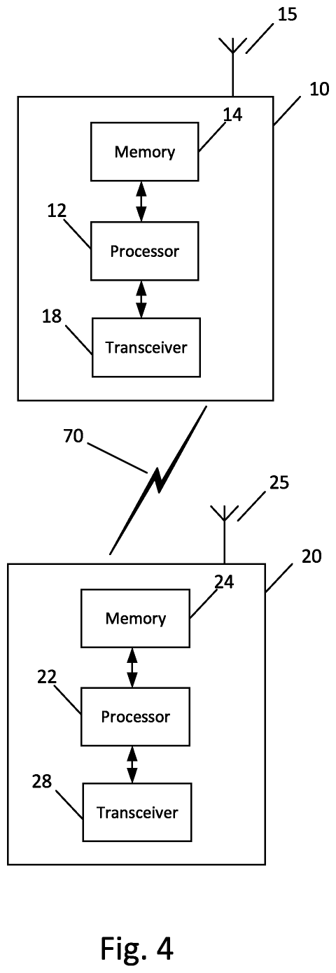

FIG. 4 illustrates an example of an apparatus 10 and apparatus 20, according to certain example embodiments. In an embodiment, apparatus 10 may be a node, host, or server in a communications network or serving such a network.

For example, apparatus 10 may be a network node, satellite, base station, a Node B, an evolved Node B (eNB), 5G Node B or access point, next generation Node B (NG-NB or gNB), TRP, HAPS, Remote Radio Head (RRH), integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection.

For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of narrow band Internet of Things (NB-IoT), LTE, 5G, Wireless Local Area Network (WLAN), Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and/or memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus may be or may be a part of a network element or RAN node, such as a base station, access point, Node B, eNB, gNB, TRP, RRH, HAPS, IAB node, relay node, WLAN access point, satellite, or the like. According to certain embodiments, apparatus 10 may be controlled by processor 12 and/or memory 14 storing instructions to perform the functions associated with any of the embodiments described herein. For example, in some embodiments, apparatus 10 may be configured to perform one or more of the processes depicted in any of the flow charts or signaling diagrams described herein, such as those illustrated in FIG. 3, or any other method described herein.

In some embodiments, as discussed herein, apparatus 10 may be configured to perform a procedure relating to pre-emptive measurement and/or alert reporting, for example, to avoid creating interference to other NTN or TN nodes. For instance, in some embodiments, apparatus 10 may be controlled by processor 12 to receive an alert report from a UE to indicate the risk of interference to other NTN or TN nodes and to initiate procedures to mitigate or prevent the interference, as described elsewhere herein.

FIG. 4 further illustrates an example of an apparatus 20 according to another embodiment. In an embodiment, apparatus 20 may be a node or element in a communications network or associated with such a network, such as a user device, UE, communication node, mobile equipment (ME), mobile station, mobile device, stationary device, IoT device, CPE, or other device.

As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, and/or one or more computer-readable storage medium (for example, memory, storage, or the like), and/or one or more radio access components (for example, a modem, a transceiver, or the like), and/or a user interface. In some embodiments, apparatus 20 may be configured to operate using one or more radio access technologies, such as LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as Orthogonal Frequency-Division Multiple Access (OFDMA) or Orthogonal Frequency Division Multiplexing (OFDM) symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20.

In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry or part of processing or control circuitry.

As discussed above, according to some embodiments, apparatus may be a user device, UE, SL UE, relay UE, mobile device, mobile station, ME, IoT device and/or NB-IoT device, CPE, or the like, for example. According to certain embodiments, apparatus 20 may be controlled by processor 22 and/or memory 24 storing instructions to perform the functions associated with any of the embodiments described herein, such as one or more of the operations illustrated in, or described with respect to, FIG. 2, or any other method described herein. For example, in an embodiment, apparatus 20 may be controlled to perform a process relating to pre-emptive measurement and/or alert reporting, as described elsewhere herein. For instance, in some embodiments, apparatus 20 may be controlled by processor 22 to detect the possibility or existence of interference and to trigger alert reporting, for example, to avoid creating interference to other NTN or TN nodes, as described elsewhere herein.

In some example embodiments, an apparatus (e.g., apparatus 10 and/or apparatus 20) may include means for performing one or more methods, processes, and/or procedures, or any of the variants discussed herein.

Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management.

For example, as discussed in detail above, certain example embodiments can provide systems and/or methods for pre-emptive interference reporting that may include measurements and signalling for a UE to provide so-called “alert reports” to a serving node (e.g., gNB/NR-RAN) allowing for preventive actions at the gNB/NR-RAN for interference management procedures so that the UE avoids creating interference to other NTN nodes or to the TN.

In an embodiment, the UE is configured to notify the serving node if the UE expects that a future uplink transmission may cause harmful interference towards neighbor cells, e.g., other NTN or TN cells. For instance, the UE may be configured to estimate if uplink transmission will cause interference in the same band or adjacent bands of the serving cell due to Doppler shift, and to alert its serving node of such risk of interference. As such, certain embodiments can reduce or avoid the risk of creating interference to other NTN or TN nodes. Accordingly, the use of certain example embodiments results in improved functioning of communications networks and their nodes, such as base stations, eNBs, gNBs, and/or IoT devices, UEs or mobile stations, or the like.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, some functionality of example embodiments may be implemented as a signal that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Some embodiments described herein may use the conjunction “and/or”. It should be noted that, when used, the term “and/or” is intended to include either of the alternatives or both of the alternatives, depending on the example embodiment or implementation. In other words, “and/or” can refer to one or the other or both, or any one or more or all, of the things or options in connection with which the conjunction is used.

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1.-61. (canceled)

62. An apparatus, comprising:
at least one processor; and
at least one memory comprising computer program code,
the at least one memory and computer program code configured, with the at least one processor, to cause the apparatus at least to:
detect a potential for creating interference to at least one network node;
based on the detection of the potential for creating the interference, transmit an alert report, to a serving node of the apparatus, to indicate the potential for creating the interference to the at least one network node.

63. The apparatus of claim 62, wherein the potential for creating the interference to the at least one network node is autonomously detected based on at least one of downlink measurements, information provided by the serving node, ephemeris information for the serving node, or Global Navigation Satellite System (GNSS) location information.

64. The apparatus of claim 62, wherein, to detect the potential for creating the interference, the at least one memory and computer program code are configured, with the at least one processor, to cause the apparatus at least to:
detect that the at least one network node is using at least one of a same carrier frequency or adjacent frequency bands as configured for the apparatus by the serving node.

65. The apparatus of claim 62, wherein, to detect the potential for creating the interference, the at least one memory and computer program code are configured, with the at least one processor, to cause the apparatus at least to:
determine whether values of the apparatus' Doppler shift and timing advance pre-compensation to be used in uplink are above certain limits that would create the interference to the at least one network node.

66. The apparatus of claim 65, wherein the at least one memory and computer program code are configured, with the at least one processor, to cause the apparatus at least to:
calculate instants in time where the Doppler shift variation exceeds said certain limits in a positive or negative direction, wherein the adjacent channel represents subcarrier or physical resource blocks in the frequency domain that can be allocated to other users.

67. The apparatus of claim 62, wherein the at least one network node comprises a neighbor satellite or high altitude platform station (HAPS), and
wherein, to detect the potential for creating the interference, the at least one memory and computer program code are configured, with the at least one processor, to cause the apparatus at least to use neighbor satellite or high altitude platform station (HAPS) information including ephemeris information to determine when the neighbor satellite or high altitude platform station (HAPS) is within range of interference in at least one of Doppler domain or time domain.

68. The apparatus of claim 67, wherein, to detect the potential for creating the interference, the at least one memory and computer program code are configured, with the at least one processor, to cause the apparatus at least to:
determine the range of interference based on the apparatus' antenna or beamforming capabilities in combination with the ephemeris information.

69. The apparatus of claim 62, wherein, to detect the potential for creating the interference, the at least one memory and computer program code are configured, with the at least one processor, to cause the apparatus at least to:
receive, from the serving node, configuration information specifying at least one of thresholds, time stamp units, or measurement objects to be reported in the alert report, and optionally receive the ephemeris information of the neighbor satellite or high altitude platform station (HAPS); and
when uplink transmission is expected to end before a window for the interference or when the apparatus is expected to be in discontinuous reception mode, defer the transmitting of the alert report.

70. The apparatus of claim 62, wherein, to detect the potential for creating the interference, the at least one memory and computer program code are configured, with the at least one processor, to cause the apparatus at least to:
identify additional interference in certain subcarriers sliding in frequency domain over time, wherein the identifying of the additional interference triggers the apparatus to search for a platform causing the additional interference.

71. An apparatus, comprising:
at least one processor;
at least one memory comprising computer program code, the at least one memory and computer program code configured, with the at least one processor, to cause the apparatus at least to:
receive an alert report, from a user equipment, to indicate a potential for creating interference to at least one network node; and
initiate interference mitigation to prevent or reduce the interference to the at least one network node.

72. The apparatus of claim 71, wherein the at least one memory and computer program are code configured, with the at least one processor, to cause the apparatus at least to:
transmit, to the user equipment, configuration information specifying at least one of thresholds, time stamp units, or measurement objects to be reported in the alert report, and to optionally transmit, to the user equipment, ephemeris information of the at least one network node.

73. An apparatus, comprising:
means for detecting a potential for creating interference to at least one network node;
based on the detecting of the potential for creating the interference, means for transmitting an alert report, to a serving node of the apparatus, to indicate the potential for creating the interference to the at least one network node.

74. The apparatus of claim 73, wherein the means for detecting comprises means for autonomously detecting the potential for creating interference to at least one network node based on at least one of downlink measurements, information provided by the serving node, ephemeris information for the serving node, or Global Navigation Satellite System (GNSS) location information.

75. The apparatus of claim 73, wherein the means for detecting comprises:
means for detecting that the at least one network node is using at least one of a same carrier frequency or adjacent frequency bands as configured for the apparatus by the serving node.

76. The apparatus of claim 73, wherein the means for detecting comprises:
means for determining whether values of the apparatus' Doppler shift and timing advance pre-compensation to be used in uplink are above certain limits that would create the interference to the at least one network node.

77. The apparatus of claim 76, further comprising:
means for calculating instants in time where the Doppler shift variation exceeds said certain limits in a positive or negative direction, wherein the adjacent channel represents subcarrier or physical resource blocks in the frequency domain that can be allocated to other users.

78. The apparatus of claim 73, wherein the at least one network node comprises a neighbor satellite or high altitude platform station (HAPS), and
wherein the means for detecting comprises means for using neighbor satellite or high altitude platform station (HAPS) information including ephemeris information to determine when the neighbor satellite or high altitude platform station (HAPS) is within range of interference in at least one of Doppler domain or time domain.

79. The apparatus of claim 78, wherein the means for detecting comprises:
means for determining the range of interference based on the apparatus' antenna or beamforming capabilities in combination with the ephemeris information.

80. The apparatus of claim 73, wherein the means for detecting comprises:
means for receiving, from the serving node, configuration information specifying at least one of thresholds, time stamp units, or measurement objects to be reported in the alert report, and optionally receiving the ephemeris information of the neighbor satellite or high altitude platform station (HAPS); and
when uplink transmission is expected to end before a window for the interference or when the apparatus is expected to be in discontinuous reception mode, means for deferring the transmitting of the alert report.

81. The apparatus of claim 73, wherein the means for detecting comprises:
means for identifying additional interference in certain subcarriers sliding in frequency domain over time, wherein the identifying of the additional interference triggers the apparatus to search for a platform causing the additional interference.
